(19) United States
(12) Patent Application Publication
(10) Pub. No.: US 2015/0121822 A1
(43) Pub. Date: May 7, 2015

(54) FILTER CAGE AND FILTER ASSEMBLY FOR BAGHOUSE FILTER

(71) Applicant: Advancetex International Pty Ltd, Deception Bay, Queensland (AU)

(72) Inventors: Michael J. Neate, Deception Bay (AU); Bradley M. Currell, Deception Bay (AU)

(73) Assignee: Advancetex International Pty Ltd., Deception Bay, Queensland (AU)

(21) Appl. No.: 14/404,911

(22) PCT Filed: Apr. 4, 2013
(86) PCT No.: PCT/AU2013/000350

§ 371 Date: Dec. 1, 2014

(30) Foreign Application Priority Data
May 31, 2012 (AU) 2012902274

(51) Int. Cl. B01D 46/00; B01D 39/14; B01D 46/08

(52) U.S. Cl. CPC B01D 46/0002; B01D 46/08; B01D 39/14
USPC 55/492

(57) ABSTRACT

Disclosed herein is a filter assembly (10). The filter assembly (10) includes a filter cage (12) having a plurality of parallel longitudinally extending members (14) that are arranged in a circular or oval configuration and which define a longitudinal axis (16). Each of the longitudinal members (14) comprises either a single longitudinal member or a pair of abutting longitudinal members. A plurality of transverse members (18) extend generally inwardly from the longitudinal members (14). The transverse members (18) each have outer ends (18a) fixedly connected to a respective one of the longitudinal members (14). A plurality of groups of the transverse members (18) are provided at longitudinally spaced apart positions, with the outer ends (18a) of the transverse members (18) in each group being circumferentially spaced apart around the circular or oval configuration to define longitudinal spaces (100) therebetween. The longitudinal members (14) and the transverse members (18) together define a frame adapted to sleevably receive a filter bag (22) thereover, the frame being adapted to retain the filter bag (22) in an open configuration upon application of negative pressure within the filter bag, in which open configuration, when viewed from a longitudinal end, the filter bag (22) adopts a zig zag or pleated filter surface area due to the bag being drawn into the longitudinal spaces (100).

### CROSS-REFERENCE TO RELATED APPLICATIONS

The present application claims priority from Australian Provisional Patent Application No 2012902274 filed on 31 May 2012, the content of which is incorporated herein by reference.

### TECHNICAL FIELD

The present disclosure relates to a filter cage and filter assembly for a baghouse filter. The filter cage has been developed primarily for use in baghouses in the aluminium smelting and power generation industries. However, may also find other useful applications, such as in cement industry dust collectors, and other industrial dust collectors.

### BACKGROUND

Known industrial filters typically include a cylindrical support cage around which is mounted a tubular filter bag. The filter bag typically includes a lower closed end and an open upper end. An air delivery system applies negative pressure to the open top of the filter bag to draw dust laden air through the filter bag and cause dust particles from the air to accumulate on the external surface of the filter bag and cleaned air to pass through the filter bag for exhaust through the open top. A plurality of the filter bags and cages are typically mounted in corresponding openings in a cell plate. The cell plate openings can be arranged in an annular array or a grid array.

Traditional pulse jet dust collector filter bags are made from synthetic non-woven needle punched or spun laced filter media and are commercially available in a variety of bag shapes and designs. Standard filter bag designs include cylindrical cross sections and oval cross sections.

Modern adaptations of these filter bag designs have been made to increase the filtration capacity of such filters, to allow either retrofit of existing capital equipment for greater capacity, or design of new capital equipment which may be smaller in size and lower in capital cost. Such adaptations include pleated cartridge filters, which are typically made of pleated spun bonded non-woven filter media. Examples of known pleated cartridge filters include German Patent 4,304,036, which discusses the construction of a cartridge filter in which a pleated non-woven fabric is transformed into a cylindrical shape and fixed to a holding device. U.S. Pat. No. 5,730,766 describes a non-circular or oval shaped cross section pleated cartridge filter. U.S. Pat. No. 5,746,792 and U.S. Pat. No. 5,536,290 describe adaptations to support structures and fitting devices for pleated cartridge filters.

Another known bag and cage construction involves both an adaptation of a conventional wire support cage and a conventional non-woven filter bag. In such a bag and cage construction, the filter cage is constructed with two parallel wires running the length of the bag to support the filter material, with the wires being spaced apart to prevent a sharp star point, as disclosed for example in U.S. Pat. No. 5,858,039 and US Patent Publication 2011/0667370 A1. Due to the two spaced longitudinal wires, these bag and cage constructions limit the number of pleats or rays in the filter bag, and therefore also limit the surface area increase of the filter bag. U.S. Pat. No. 5,858,039 promises an increase in available filtration area compared to a conventional filter bag of between 1.7 to 2.2 times greater surface area and discloses eight pairs of twin longitudinal wires to provide eight pleats or rays in the associated filter bag. US Patent Publication 2011/0667370 A1 describes constructions providing for up to nine pleats or rays for a specified filter diameter, and outlines an increase in available filter area of 100% or twice the conventional filter area.

Any discussion of documents, acts, materials, devices, articles or the like which has been, included in the present specification is not to be taken as an admission that any or all of these matters form part of the prior art base or were common general knowledge in the field relevant to the present invention as it existed before the priority date of each claim of this application.

### SUMMARY

In a first aspect, the present disclosure provides a filter cage for supporting a filter bag, the filter cage including:

a plurality of parallel longitudinal members arranged in a generally circular or oval configuration, the longitudinal members defining a longitudinal axis of the filter cage;

a plurality of transverse members extending generally inwardly from the longitudinal members, the transverse members each having an outer end fixedly connected to a respective one of the longitudinal members, wherein a plurality of groups of the transverse members are provided at longitudinally spaced apart positions, and wherein the outer ends of the transverse members of each group are circumferentially spaced apart around the circumference of the circular or oval configuration so as to define longitudinal spaces therebetween extending from one longitudinal end of the cage to the other longitudinal end of the cage, and wherein the transverse members of each group are fixedly connected to the other transverse members of the same group;

the longitudinal members and the transverse members defining a frame adapted to sleevably receive a filter bag thereover;

wherein each of the longitudinal members comprises either a single longitudinal member or a pair of abutting longitudinal members, and

wherein the frame is adapted to retain the filter bag in an open configuration upon application of negative pressure within the filter bag, in which open configuration, when viewed from a longitudinal end, the filter bag adopts a zig zag or pleated filter surface area due to the bag being drawn into the longitudinal spaces between the transverse members.

A collar may be removably connected to one longitudinal end of the frame. The collar may be adapted to have an open end of the filter bag connected thereto. In other embodiments, the collar may be integral with the frame, for example by being welded to one longitudinal end of the frame.

In embodiments where the longitudinal members are arranged in a generally circular configuration, the radially inner ends of the transverse members in each said group may be fixedly connected together by a ring. The ring associated with each group of transverse members may be concentric with the rings associated with the other groups of transverse members. The centre of each said ring may be aligned on the longitudinal axis.

In embodiments where the longitudinal members are arranged in a generally oval configuration having a major axis and a minor axis, each group of the transverse members may include at least one transverse member extending substantially parallel to the major axis of the oval configuration and a plurality of transverse members extending substantially perpendicularly to the major axis.

A further aspect provides a filter assembly comprising:

a filter cage according to the first aspect above; and

a filter bag sleeved over the frame and retained in an open configuration by the frame upon application of negative pressure within the filter bag, in which open configuration, when viewed from a longitudinal end, the filter bag adopts a zig zag or pleated filter surface area due to the bag being drawn into the longitudinal spaces between the transverse members.

The filter bag may be formed from a non-woven fabric. The diameter of the filter bag may be greater than the diameter of the frame.

### BRIEF DESCRIPTION OF DRAWINGS

An embodiment of the presently disclosed filter cage and filter assembly will now be described, by way of example only, with reference to the accompanying drawings, in which:

FIG. 1 shows a side elevational view of a first embodiment of a filter assembly according to the present disclosure, wherein the filter bag is omitted to allow the filter cage to be seen;

FIG. 2 is a cross-sectional view taken along line B-B of FIG. 1;

FIG. 3 is a cross-sectional view taken along line A-A of FIG. 1;

FIG. 4 is a cross-sectional view of the filter cage of the filter assembly of FIG. 1, taken along line B-B of FIG. 1 and showing a filter bag sleeved thereover; and

FIG. 5 is a cross-sectional view of a second embodiment of a filter cage similar to that of FIG. 4.

### DESCRIPTION OF EMBODIMENTS

Referring to the drawings, there is shown a filter assembly 10. The filter assembly 10 includes a filter cage 12 having a plurality of parallel longitudinally extending members 14 that are arranged in a circular configuration and which define a longitudinal axis 16. A plurality of transverse members 18 extend generally radially inwardly from the longitudinal members 14. The transverse members 18 each have a radially outer end 18a fixedly connected to a respective one of the longitudinal members 14 and terminate in a radially inner end 18b. A plurality of groups of the transverse members 18 are provided at longitudinally spaced apart positions, with outer ends of the transverse members 18 in each group being circumferentially spaced apart around the longitudinal axis 16 so as to define longitudinal spaces 100 therebetween extending from one longitudinal end of the filter cage 12 to the other. The transverse members 18 in each group are fixedly connected together via a ring 20 connected to their radially inner ends 18b. The transverse members 18 of each group angularly align with the transverse members 18 of the other groups and the rings 20 associated with each group of transverse members 18 are concentric.

The longitudinal members 14 and the transverse members 18 together define a frame adapted to sleevably receive a filter bag 22 thereover. The filter bag 22 is has an open end and a closed end.

In the illustrated embodiments, each of the longitudinal members 14 comprises a pair of abutting longitudinal members that are in register with each other along their length. In other embodiments, however, a single longitudinal member may be connected to the outer end 18a of each transverse member 18.

The frame 14, 18 is adapted to retain the filter bag 22 in an open configuration upon application of negative pressure within the filter bag 22. This negative pressure is generated by an air delivery system associated with the filter assembly 10, as is well understood in the art and therefore not described in further detail herein. In the open configuration, when viewed from a longitudinal end, the filter bag 22 adopts a zig zag or pleated filter surface area due to the bag 22 being drawn into the longitudinal spaces 100 between the transverse members 18.

As shown in FIG. 1, a collar 24 is connected to one longitudinal end of the frame 14, 18. The collar may be fixedly connected to or integral with the frame, such as by welding, or removably connected to the frame.

In use, the open end of the filter bag 22 is sleeved over the frame 14, 18 and drawn up toward the collar 24 for connection to a cell plate in which the filter assembly 10 is installed. The bag 22 is sized such that when sleeved over the frame 14, 18 and drawn up toward the collar 24, the closed end is located closely adjacent the end of the frame 14, 18 remote from the collar 24.

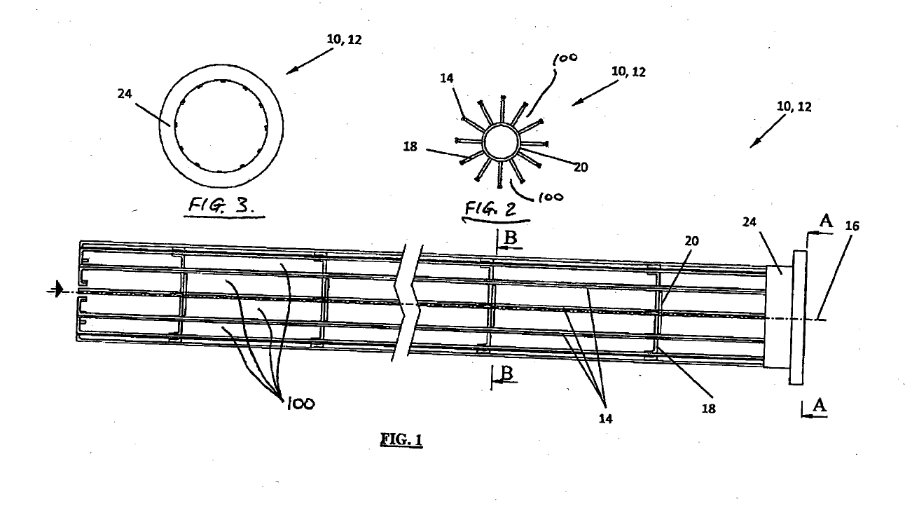

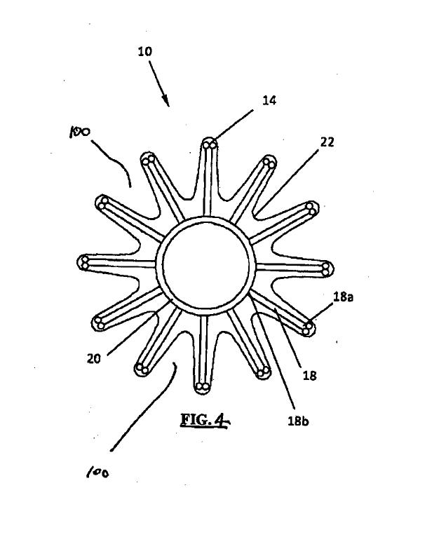

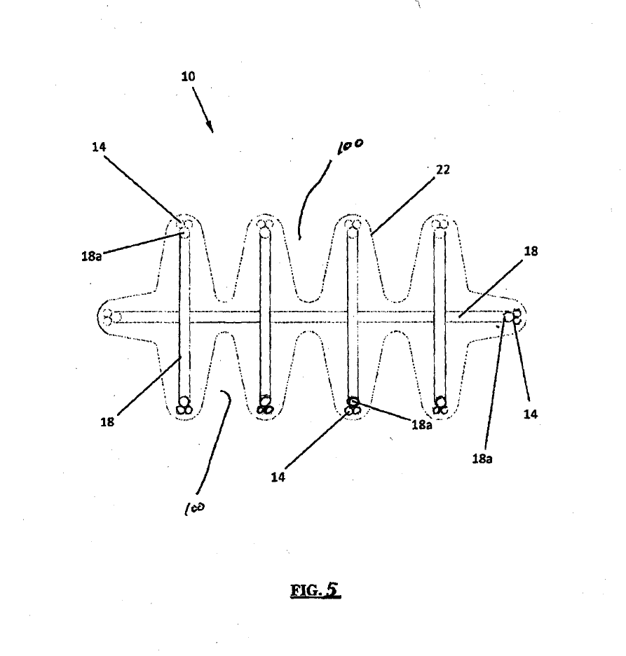

As best seen in FIGS. 2 and 4, when viewed from a longitudinal end, the frame 14, 18 has a configuration that causes the filter bag 22 to, adopt a zig zag or pleated filter surface area when sleeved over the frame and the negative pressure is applied within the filter bag 22 due to the bag 22 being drawn into the longitudinal spaces 100 between the transverse members 18.

The filter bag 22 is formed from a non-woven fabric. The diameter of the filter bag 22 is greater than the diameter of the frame 14, 18, such that excess filter bag material is drawn radially inwardly, upon application of negative pressure within the bag 22, to conform to a shape imparted by the frame.

A second embodiment of the filter cage 12 is shown in FIG. 5, and has many features in common with FIGS. 1-4, where corresponding reference numerals indicate corresponding features with corresponding functions. In the FIG. 5 embodiment, however, the longitudinal members 14 are arranged in an oval configuration having a major axis 110 and a minor axis 120. In the illustrated embodiment, each group of the transverse members 18 includes one transverse member extending substantially parallel to the major axis 110 and a plurality of transverse members 18 extending substantially perpendicularly to the major axis 110. However, in other oval embodiments, each group of transverse members 18 may include more than one transverse member 18 that extends parallel to the major axis 110.

It will be appreciated that the paired abutting longitudinal members 14 of the above described filter cage 12 allows a relatively high number of folds/pleats to be provided in the filter bag 22 compared to the limited number of folds/pleats provided in prior art filter assemblies where the number of folds/pleats is limited by the use of formations to hold open the radially outer end of each fold/pleat. As such, the illustrated filter cage 12 and filter assembly 10 facilitate increasing the filtration capacity of existing filter baghouse housings by providing an increased filter surface area compared to prior art filter assemblies by providing an increased filtration surface area. It is expected that the above described filter cage 12 and filter assembly 10 will provide a filtration surface area increase over conventional filters of up to 3 times for the same length bag 22. Moreover, with the illustrated filter cage 12 and filter assembly 10, an increase in filtration capacity is facilitated without the need for high capital costs, such as are required with the addition of extra baghouses, or the structural modification of existing baghouses.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A filter cage for supporting a filter bag, the filter cage including:
a plurality of parallel longitudinal members arranged in a generally circular or oval configuration, the longitudinal members defining a longitudinal axis of the filter cage;
a plurality of transverse members extending generally inwardly from the longitudinal members, the transverse members each having an outer end fixedly connected to a respective one of the longitudinal members, wherein a plurality of groups of the transverse members are provided at longitudinally spaced apart positions, and wherein the outer ends of the transverse members of each group are circumferentially spaced apart around the circumference of the circular or oval configuration so as to define longitudinal spaces there between extending from one longitudinal end of the cage to the other longitudinal end of the cage, and wherein the transverse members of each group are fixedly connected to the other transverse members of the same group;
the longitudinal members and the transverse members defining a frame adapted to sleevably receive a filter bag thereover;
wherein each of the longitudinal members comprises either a single longitudinal member or a pair of abutting longitudinal members, and
wherein the frame is adapted to retain the filter bag in an open configuration upon application of negative pressure within the filter bag, in which open configuration, when viewed from a longitudinal end, the filter bag adopts a zig zag or pleated filter surface area due to the bag being drawn into the longitudinal spaces between the transverse members.

2. A filter cage according to claim 1, wherein the longitudinal members are arranged in a generally circular configuration and radially inner ends of the transverse members in each said group are fixedly connected together by a ring.

3. A filter cage according to claim 2, wherein the ring associated with each group of transverse members is concentric with the rings associated with the other groups of transverse members.

4. A filter cage according to claim 3, wherein the centre of each said ring is aligned on a central longitudinal axis of the filter cage.

5. A filter cage according to claim 1, wherein the longitudinal members are arranged in a generally oval configuration having a major axis and a minor axis, and wherein each group of the transverse members includes at least one transverse member extending substantially parallel to the major axis of the oval configuration and a plurality of transverse members extending substantially perpendicularly to the major axis.

6. A filter cage according to claim 1, comprising a collar removably connected to one longitudinal end of the frame.

7. A filter cage according to claim 1, comprising a collar connected to one longitudinal end of the frame, wherein the collar is integral with the frame.

8. A filter cage according to claim 6, wherein the collar is adapted to have an open end of the filter bag connected thereto.

9. A filter assembly comprising:
a filter cage according to claim 1; and
a filter bag sleeved over the frame and retained in an open configuration by the frame upon application of negative pressure within the filter bag, in which open configuration, when viewed from a longitudinal end, the filter bag adopts a zig zag or pleated filter surface area due to the bag being drawn into the longitudinal spaces between the transverse members.

10. A filter assembly according to claim 9, wherein the diameter of the filter bag is greater than the diameter of the frame.

11. A filter assembly according to claim 9, wherein filter bag is formed from a non-woven fabric.
